(19) United States
(12) Patent Application Publication
(10) Pub. No.: US 2026/0107340 A1
(43) Pub. Date: Apr. 16, 2026

(54) INDICATION OF GENERATION CORRESPONDING TO UPDATED PARAMETERS

(71) Applicant: Laurent Cariou, Milizac (FR)

(72) Inventor: Laurent Cariou, Milizac (FR)

(21) Appl. No.: 19/422,663

(22) Filed: Dec. 17, 2025

Related U.S. Application Data
(60) Provisional application No. 63/749,401, filed on Jan. 24, 2025.
(60) Provisional application No. 63/794,496, filed on Apr. 25, 2025.

(51) Int. Cl. H04W 76/15

(52) U.S. Cl. CPC H04W 76/15

(57) ABSTRACT

This disclosure describes systems, methods, and devices for enhanced generation indication. A device determines an Ultra High Reliability Basic Service Set Parameters Change Count (UHR BPCC) field, configured for inclusion in a multi-link element and a Reduced Neighbor Report (RNR) of a management frame. The device increments the UHR BPCC and the critical update generation field and sets a critical update flag in a Beacon frame transmitted by an access point (AP). This flag is maintained for a specified duration of at least one Delivery Traffic Indication Map (DTIM) interval to indicate a parameter change. The device also includes updated elements in the Beacon frame for that duration, detailing the critical update generation, target link, TBTT countdown, updated feature, and the timing of update inclusion.

### CROSS-REFERENCE TO RELATED PATENT APPLICATION(S)

This application claims the benefit of U.S. Provisional Application No. 63/749,401, filed Jan. 24, 2025, and of U.S. Provisional Application No. 63/794,496, filed Apr. 25, 2025, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for enhanced generation indication, in accordance with one or more example embodiments of the present disclosure.

FIG. 2 illustrates a flow diagram of a process for an illustrative enhanced generation indication system, in accordance with one or more example embodiments of the present disclosure.

FIG. 3 illustrates a functional diagram of an exemplary communication station that may be suitable for use as a user device, in accordance with one or more example embodiments of the present disclosure.

FIG. 4 illustrates a block diagram of an example machine upon which any of one or more techniques (e.g., methods) may be performed, in accordance with one or more example embodiments of the present disclosure.

FIG. 5 is a block diagram of a radio architecture in accordance with some examples.

FIG. 6 illustrates an example front-end module circuitry for use in the radio architecture of FIG. 5, in accordance with one or more example embodiments of the present disclosure.

FIG. 7 illustrates an example radio IC circuitry for use in the radio architecture of FIG. 5, in accordance with one or more example embodiments of the present disclosure.

FIG. 8 illustrates an example baseband processing circuitry for use in the radio architecture of FIG. 5, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

Since several years, there is a growing concern on Beacon frames becoming too large, especially in enterprise scenarios with Multiple BSSID set. Small patches have been continuously provided in the 802.11 specification (“spec”) for this issue, but the issue has never been resolved with a long-term perspective.

To address this long-standing issue, a solution is proposed that offers compatibility with legacy devices (STAs) and can be adapted for future greenfield UHR deployments.

What is carried in Beacon frames and how is it used?

Today's Beacon frames carry 2 types of information:
1—basic service set (BSS) parameters: Capabilities and BSS operational information. Long term information that barely changes.
2—Dynamic operational elements: Dynamic information needed for basic operation of associated STAs. TIM element is a good example.

Dynamic operational elements have to be present in all Beacon frames.

For BSS parameters on the contrary:
The parameters barely change and if they do, there is the critical update procedure for associated STAs to be aware of changes and get the updates (today in 11be, the critical update indicates whether the parsing of the beacon is needed or not and all elements are included in beacon (per link). So, with regards to associated STAs, there is no need to include any of these in Beacon frames assuming some small evolution of the critical update procedure.
Unassociated STAs sometimes need just basic discovery information (BSSID, SSID, security parameters, what generation is supported, . . . ) and obviously sometimes need to retrieve the complete information, which they can get through probing. So, with regards to unassociated STAs, there is a need for basic discovery information to find good balance with probing.

The general direction to reduce beacon bloat would be as follows:

Starting from UHR/11bn generation, Beacon frames of a UHR AP carry only the following:
All the dynamic operational elements category (TIM, . . . ).
Only the basic discovery information within the BSS parameters category.
   Basic discovery information elements can be defined as follows for example:
      BSSID, SSID, supported rates, generation support, MLD support, basic security info, . . . mostly what is needed when performing full scan with the intent to present to the user the list of available networks around.

There is a need to derive the BSS parameter critical update procedure in this context.

For example, in a typical enterprise environment where multiple access points are deployed with Multiple BSSID sets, each Beacon frame can include information for several BSSIDs. If every Beacon frame includes all the long-term BSS parameters for each BSSID, the frame size increases significantly, which can lead to increased airtime usage and potential delays in transmission. By limiting the Beacon frames to only dynamic operational elements and essential discovery information, the overhead is reduced, improving overall network efficiency. In this scenario, an associated STA that needs to know about a recent change in BSS capabilities can rely on the critical update indication and retrieve updated parameters only when necessary, rather than parsing large Beacons continuously.

For another example, consider an unassociated STA scanning for available networks. During the scanning process, the device receives Beacon frames containing only the BSSID, SSID, supported rates, and basic security information. This allows the device to quickly build a list of available networks without being burdened by unnecessary details. If the device requires more specific operational parameters before association, it can send a probe request to the AP, which will respond with the complete set of information. This approach ensures that Beacon frames remain concise while still supporting robust network discovery and association procedures.

Additionally, the critical update procedure can be adapted to fit this model by indicating, within the Beacon frame, whether a change has occurred in the long-term BSS parameters. For example, if an AP modifies its supported rates or updates security capabilities, the critical update indication is set, prompting associated STAs to fetch the new parameters. This targeted update mechanism reduces unnecessary data transmission and ensures that only relevant devices process updated information, further optimizing network performance.

Small patches are provided in the 802.11 specification (“spec”) for this issue, but never really resolve this issue with a long-term perspective.

It is time to provide solutions for a long-term fix, it is proposed in this disclosure propose a solution compatible with legacy devices (STAs), which can be adapted to greenfield UHR deployments as well.

What is carried in Beacon frames and how is it used?

Beacon frames today carry 2 types of information.

BSS parameters: Capabilities and BSS operational information.

Long term information that barely changes.

Dynamic operational elements: Dynamic information needed for basic operation of associated STAs.

TIM element is a good example.

Dynamic operational elements have to be present in all Beacon frames.

For BSS parameters on the contrary:

The parameters barely change and if they do, the critical update procedure exists for associated STAs to be aware of changes and get the updates (today in 11be, the critical update indicates whether the parsing of the beacon is needed or not and all elements are included in beacon (per link).

So with regards to associated STAs, it is not desired to need to include any of these in Beacon frames assuming some small evolution of the critical update procedure.

Unassociated STAs sometimes need just basic discovery information (BSSID, SSID, security parameters, what generation is supported, . . . ) and obviously sometimes need to retrieve the complete information, which they can get through probing.

So with regards to unassociated STAs, it is needed basic discovery information to find good balance with probing.

The general direction to reduce beacon bloat would be as follows:

Starting from UHR/11bn generation, Beacon frames of a UHR AP carry only the following:

All the dynamic operational elements category (TIM, . . . ).

Only the basic discovery information within the BSS parameters category.

Basic discovery information elements can be defined as follows for example:

BSSID, SSID, supported rates, generation support, MLD support, basic security info, etc., mostly what is needed when performing full scan with the intent to present to the user the list of available networks around.

Considering a network deployment where multiple access points operate within a large enterprise. In such scenarios, each Beacon frame transmitted by an access point may include only the essential dynamic operational elements, such as the TIM element, and the basic discovery information necessary for client devices to identify available networks. By limiting the Beacon frame contents in this manner, the overall frame size is reduced, resulting in improved transmission efficiency and reduced channel occupancy. This approach allows devices performing network scans to quickly compile a list of available networks based on concise Beacon frames without processing extraneous data. For example, in the context of an associated STA, when a change occurs in long-term BSS parameters, such as an update to supported rates or security capabilities, the critical update procedure provides an indication within the Beacon frame. This indication signals to associated client devices that a change has occurred, prompting them to retrieve the updated parameters as needed. This targeted notification mechanism ensures that only relevant devices process updated information, minimizing unnecessary overhead and maintaining synchronization with the access point's capabilities.

During network discovery by an unassociated STA, the device receives Beacon frames containing only the BSSID, SSID, supported rates, generation support, and basic security information. This enables the device to identify viable networks for potential association efficiently. If the device requires further operational details—such as advanced configuration parameters or additional security capabilities—it may initiate a probe request to the access point. The access point then responds with a comprehensive set of information, ensuring that the device receives all necessary data for secure and optimal association while keeping routine Beacon transmissions minimal. For example, the implementation of the critical update procedure allows for seamless adaptation to network changes without requiring continuous inclusion of static BSS parameters in every Beacon frame. When an access point modifies its capabilities or updates operational characteristics, the critical update indication is set in the Beacon frame, alerting associated STAs to fetch the latest information. This mechanism supports efficient network management and reduces channel load, as only the devices affected by the update engage in additional information exchange. For example, in greenfield UHR deployments, where legacy device compatibility may not be a concern, Beacon frames can be optimized further by excluding all non-essential elements and relying exclusively on dynamic operational elements and basic discovery information. This strategy enhances network scalability and performance, especially in environments with high device density, by reducing airtime consumption and accelerating network discovery procedures.

Example embodiments of the present disclosure relate to systems, methods, and devices for Indication of generation corresponding to updated parameters.

In one or more embodiments, it is proposed to enhance the current critical update procedure and to allow the following indications: generation of the update (WiFi7, WiFi8, . . . ), whether the updated elements are included or not, and indication of the time at which the parameters will be updated (count down). Using this mechanism, Client will typically be fully synched with the AP's capabilities (even if “static” elements that are not going to be included in UHR beacon have changed) without using the Request/Response operation that is both time-consuming and increases the Channel-Load.

In wireless networking, the process of updating configuration parameters between a client device and an access point may be critical for maintaining efficient and secure communication. The critical update procedure refers to a method by which an access point may signal to connected client devices that certain operational parameters have changed. These operational parameters may include, for example, the supported data rates, security capabilities, or network generation features. When such updates occur, it is important for client devices to be notified promptly so they can adjust their operation in accordance with the new network configuration.

The indication of the network generation associated with updated parameters may be essential in environments where multiple generations of wireless technology coexist. For example, an access point supporting WiFi7 and WiFi8 may need to inform client devices which generation the updated parameters pertain to. This indication could enable client devices to determine whether the update is relevant to their capabilities and to adjust their interactions with the network accordingly. The generation information may be included in a dedicated field or element within the signaling frames transmitted by the access point.

Another aspect of the enhanced procedure may involve specifying whether the updated elements are included within the signaling message or require separate retrieval by the client device. This distinction could be important for minimizing unnecessary communication overhead. For example, when only a subset of parameters are updated, the access point may indicate that the updated elements are present in the current frame. Alternatively, if the parameters are not included, the client device may be prompted to initiate a probe request to obtain the complete set of updated information.

A further refinement of the update indication mechanism may be the inclusion of a timing parameter that specifies when the updated parameters will become effective. This timing parameter could be expressed as a countdown value. By providing this information, client devices may synchronize their configuration changes with the access point, ensuring a seamless transition to the new operational state. For example, if an access point plans to change its supported rates after a predetermined interval, the countdown indication may allow all connected devices to prepare for the change in advance, reducing the likelihood of communication failures or service interruptions.

The synchronization mechanism enabled by these enhancements may operate as follows. First, the access point detects a change in one or more operational parameters. Next, the access point generates a signaling frame, such as a beacon frame, that includes the generation indication, an inclusion flag for updated elements, and a timing parameter for the update. Client devices receiving this frame may evaluate the information to determine if the update is relevant and, if necessary, retrieve additional parameters or adjust their settings. This stepwise approach may minimize the need for frequent request and response exchanges, thereby reducing channel load and improving overall network efficiency.

For example, in a deployment where multiple client devices are connected to a single access point, the access point may use the enhanced critical update procedure to notify only those devices affected by a change in Wi-Fi generation parameters. Devices that do not support the indicated generation may disregard the update, while compatible devices may synchronize their settings based on the provided timing information. This targeted notification approach may facilitate efficient network management and help maintain compatibility across diverse device types.

The optimization of beacon frames, which are periodic broadcast messages used to advertise network parameters, may further contribute to improved wireless network performance. By including only essential dynamic elements and basic discovery information in beacon frames, and delegating detailed updates to the critical update procedure, the system may reduce unnecessary airtime consumption. This approach could be particularly beneficial in environments with high device density, where minimizing channel occupancy is a priority for maintaining reliable and fast communication.

In one or more embodiments, a device or a system may comprise one or more components, which may include one or more of: apparatus, station (STA), access point (AP), and/or other network elements. At its most basic configuration, the device or system includes one or more processors, memory, and instructions. The processor(s) may be implemented using general-purpose microprocessors, digital signal processors (DSPs), field-programmable gate arrays (FPGAs), or other suitable computational entities capable of performing calculations or manipulations of information. The memory may include RAM, ROM, flash memory, or other storage media suitable for storing instructions and data necessary for system operation. These components, individually or in combination, enable the execution of processes that facilitate communication and functionality within the system.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

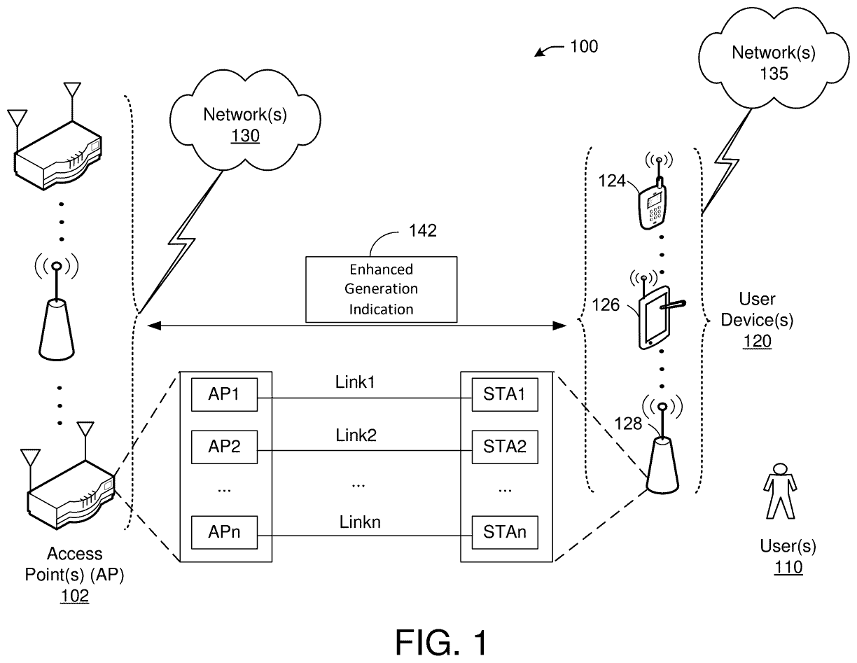

FIG. 1 is a network diagram illustrating an example network environment of enhanced generation indication, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

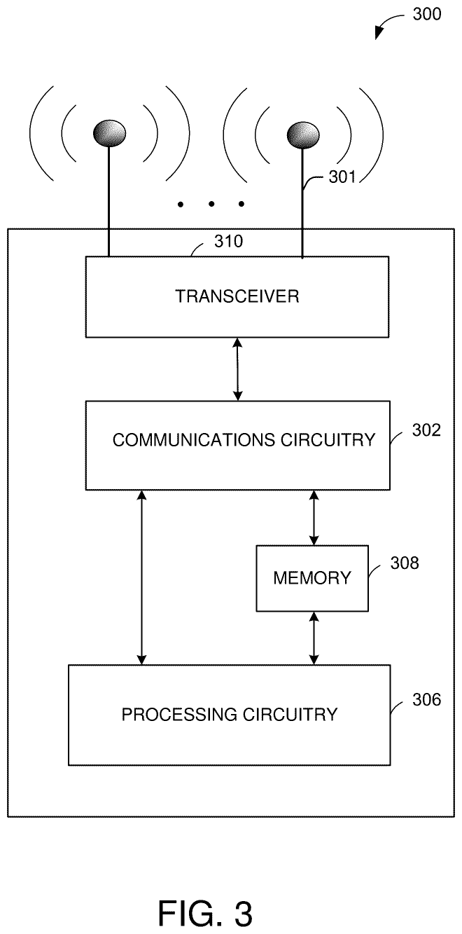

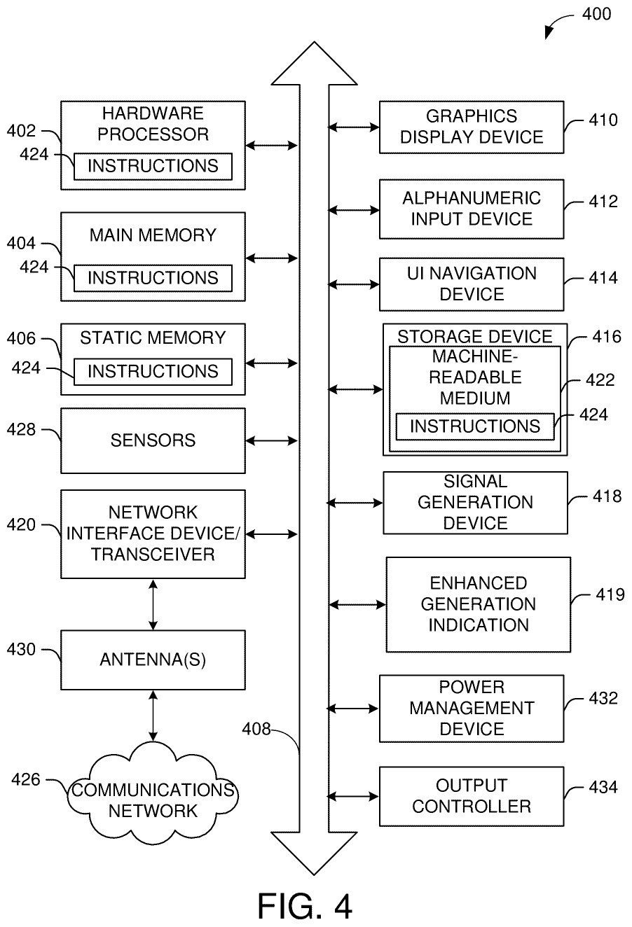

In some embodiments, the user devices 120 and the AP 102 may include one or more computer systems similar to that of the functional diagram of FIG. 3 and/or the example machine/system of FIG. 4.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an enhanced generation indication 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

In one or more embodiments, it is proposed to define a new UHR BSS Parameters Change Count (BPCC) field, which can be included in the multi-link element the same way as the BSS Parameters Change Count field.

For APs affiliated with the same AP MLD as the AP sending the frame, the UHR BPCC is included in the RNR.

For APs corresponding to nonTx BSSID in the same Multiple BSSID set as the AP sending the frame, the UHR BPCC is included in the RNR.

For APs affiliated with the same AP MLD as a nonTx BSSID in the same Multiple BSSID set as the AP sending the frame, the UHR BPCC is included in the RNR.

This new field is incremented when a BSS Parameter (that is not typically included in the Beacon frames, e.g. not a dynamic element) gets updated by the AP.

In the same location as the UHR BPCC (ML element and RNR), it is proposed to include the generation of the critical update that corresponds to the UHR BPCC.

A value for IEEE 802.11bn (11bn), reserved for next generations following 11bn.

That would mean that there is such Critical Update Generation field (of 3 bits probably) to be included along the BPCC field in the RNR and the ML element (or any other location where this is included).

When such BSS Parameter element gets changed by the AP, the following applies in the Beacon frames transmitted by the AP:

The critical update flag is set to 1 until next DTIM, and preferably for multiple DTIMs. Likely there would be a need to define a new UHR Critical Update flag that is only referring to changes in elements that are to not typically included in the Beacon frames, e.g. not a dynamic element.

The UHR BSS Parameters Change Count field is incremented by 1 (or the EHT BSS Parameters Change Count is incremented by 1 if it is desired to reuse the current procedure. If a UHR BSS Parameters Change Count is defined, it is possible to define it so that it applies for the MLD or for each AP of the AP MLD independently.

The BSS Parameters Change Count does not get incremented (unless the BSS parameters change correspond to a critical event as defined in 11be or unless it is decided to not define the UHR BSS Parameters Change Count field as discussed in previous sub-bullet).

In one or more embodiments, modifications to critical update procedure include:

Critical update procedure is used today for early Beacon dropping, and to identify changes on other links as well as on the link on which the Beacon was transmitted. Here, it is possible to use it to be aware of any changes that occur to any BSS parameter changes.

The Current Critical update procedure is as follows:

If a BSS parameter (on the link on which the Beacon was transmitted, or on another link that is a member in same MLD as the link on which the Beacon was transmitted) gets updated by the AP:

The critical Update flag is set to 1 until next DTIM.

The BSS Parameter Change Counter that refers to the link on which the change occurred and corresponding to this change is incremented by 1.

If the updated elements are on another link that is a member in same MLD as the link on which the Beacon was transmitted, and those changed elements are included in the Beacon, the “All Updates Included” field is set to 1, otherwise it is set to 0.

Current mechanisms do not differentiate between dynamic/static elements.

New proposed critical update:

In one or more embodiments, it is proposed to define a new UHR BSS Parameters Change Count field, which can be included in the Multi-link element the same way as the BSS Parameters Change Count field.

This new field is incremented when a BSS Parameter (that is not typically included in the Beacon frames, e.g. not a dynamic element) gets updated by the AP.

When such BSS Parameter element gets changed by the AP, the following applies in the Beacon frames transmitted by the AP:

The critical update flag is set to 1 until next DTIM, and preferably for multiple DTIMs

Likely, there may be a need to define a new UHR Critical Update flag that is only referring to changes in elements that are to not typically included in the Beacon frames, e.g. not a dynamic element.

The UHR BSS Parameters Change Count field is incremented by 1 (or the EHT BSS Parameters Change Count is incremented by 1 if it is needed to reuse the current procedure.

If it is needed to define a UHR BSS Parameters Change Count, it is possible to define it so that it applies for the MLD or for each AP of the AP MLD independently.

The BSS Parameters Change Count does not get incremented (unless the BSS parameters change correspond to a critical event as defined in 11be or unless it is decided to not define the UHR BSS Parameters Change Count field as discussed in previous sub-bullet).

The new updated elements corresponding to this event are included in the Beacon frames for a pre-defined duration (multiple DTIMs) in a specific element designed to include these updated elements.

This can be a new element, for instance called “Changed Elements Container” or “Critical Update element”.

Or it is possible to reuse and modify the “Reconfiguration Multi-link element”.

It is proposed that this “Critical update element includes some of the following:

The generation of the critical update.

A value for 11bn, reserved for next generations following 11bn.

The link on which the updates apply (if the UHR Parameters change count is per MLD).

A count down in number of TBTTs before the new parameters take effect.

The feature that gets an update.

Note that this field can be designed so that it embeds both the feature and the generation.

A field indicating if the updates or included in the Beacon frame, or in a subsequent frame that immediately follows or in an unsolicited Probe response frame that immediately follows.

The subelement that includes the parameters that are updated or the fields that are updated.

Similarly, the subelement ID can be used to indicate the generation of the updates for instance.

For example, if there's an update to the NPCA Parameters (enable/disable, Transition delays, etc.) and if these parameters are typically included in the UHR operation elements, when it wants to start advertising the updates, the AP does the following: keep advertising the current parameters in the operation element in the core of the Beacon frame; set CUF to 1 to indicate that there is a critical update coming; add +1 to the UHR BSS Parameters Change Count field or to the BSS Parameters Change Count field; set the field All Updates Included to 1; include the Critical Update element in the Beacon frame; and include the parameter change (which can be the UHR Operation element or just the field that will be changed)—there can be multiple parameters that are changed at the same time, in which case there are multiple parameters that are included in the element.

In case it is desired to limit just to the field, it is proposed to define a Parameter Update Type field that can be set to a specific entry for each Parameter that can be changed (Dynamic UHR Operating BW, NPCA Primary Channel, . . . ) and a Parameter field or list of parameters that can be included right after the Parameter Update Type field and that corresponds to the Parameter.

Include the LinkID corresponding to the affiliated AP of the AP MLD that will have a parameter change.

Include a Beacon Count Down field that indicates the number of Beacon Intervals before the change occurs.

To clarify the preceding description for readers unfamiliar with wireless networking, below are explanations of relevant technical terms and concepts. A “Basic Service Set” (BSS) refers to a group of wireless devices (including access points and client stations) communicating using a specific wireless protocol within a defined area, governed by parameters such as security settings and channel assignments. “Access Points” (APs) facilitate wireless connectivity by transmitting and receiving data between client devices and the wired network. A “Multi Link Device” (MLD) can manage multiple communication links simultaneously; an “AP MLD” is an access point with this capability, while a “non AP MLD” is a client station with similar features. “NonTx BSSID” designates a Basic Service Set Identifier for a non transmitting AP within a set of multiple BSSIDs managed by a single AP.

The Ultra High Reliability (UHR) BSS Parameters Change Count (BPCC) field tracks changes to BSS parameters not typically included in Beacon frames, which are management frames broadcasting essential network information. The UHR BPCC field can be included in the Multi Link (ML) element of management frames and in the Reduced Neighbor Report (RNR), which shares information about neighboring networks and APs. When an AP updates a BSS parameter not commonly broadcast within Beacon frames, the UHR BPCC field is incremented to indicate a change. This increment can be applied independently per AP within an AP MLD or collectively for the entire MLD, depending on implementation.

The RNR advertises neighboring AP details to assist client devices in network selection and roaming, while the ML element in management frames provides information on multi link operations. By including the UHR BPCC field and a critical update generation field within these elements, APs provide timely and accurate information about parameter changes that affect reliability or performance.

Tracking BSS parameter changes is essential in environments where network reliability and prompt updates are critical. For example, if a network administrator modifies a configuration (not typically reflected in Beacon frames), such as an advanced security setting, the UHR BPCC field is incremented and the critical update flag is set. This ensures client devices and other APs are aware of the update and can adjust behavior accordingly. The critical update flag, set in the Beacon frame, may persist for multiple Delivery Traffic Indication Map (DTIM) intervals to ensure robust notification.

For instance, if an AP updates a device authentication protocol parameter (not a dynamic element and not included in regular Beacons), the UHR BPCC is incremented and the critical update flag is set. This information is propagated through RNR and ML elements, allowing relevant devices to be promptly informed. Reserved values in the critical update generation field support future enhancements, such as additional parameters introduced by new standards like IEEE 802.11bn.

The described mechanisms for managing and tracking BSS parameter changes enhance the reliability and adaptability of wireless networks. By signaling updates not typically included in Beacon frames, APs and client devices can maintain synchronized configurations and respond efficiently to changes, especially in complex multi link environments where coordinated operation across multiple APs and client stations is vital.

When a BSS parameter not broadcast in Beacon frames is updated, the critical update flag is set in the Beacon frame for a defined duration (potentially spanning multiple DTIM intervals). Updated elements may be included in a specialized Beacon frame element (such as a “Critical Update element”), containing details like the critical update generation, targeted link, countdown of Target Beacon Transmission Times (TBTTs) before new parameters take effect, and identification of specific updated features.

For example, if an AP modifies a Non Persistent Channel Assignment (NPCA) parameter, the AP continues advertising existing parameters, sets the critical update flag, and increments the UHR BPCC field. It may include a Critical Update element specifying the nature of the change, the affected link, and a countdown for when the change becomes effective. Multiple parameters can be listed if several are updated simultaneously, with fields distinguishing the change type, affected parameters, affiliated AP (via LinkID), and Beacon Countdown.

These mechanisms enhance wireless network robustness and responsiveness, especially where reliability and timely updates are essential. By systematically tracking and signaling changes to both dynamic and static BSS parameters, APs and client devices maintain coordinated operation and adapt efficiently to evolving network conditions, particularly beneficial in complex multi-link deployments requiring synchronized updates across multiple APs and client stations for optimal performance and user experience.

It is understood that the above descriptions are for the purposes of illustration and are not meant to be limiting.

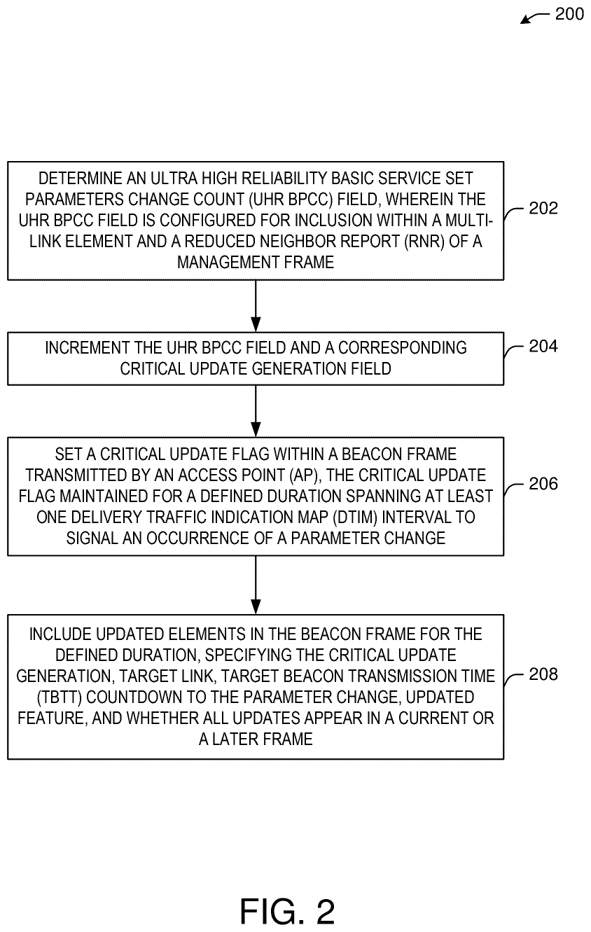

FIG. 2 illustrates a flow diagram of illustrative process 200 for an enhanced generation indication system, in accordance with one or more example embodiments of the present disclosure.

The process described in FIG. 2 may be implemented by a communication station as depicted in FIG. 3 or a machine or system as shown in FIG. 4, providing a comprehensive framework for managing and signaling critical parameter changes within wireless networks.

At block 202, a device such as user device 120, access point 102 (see FIG. 1), or the enhanced generation indication device 419 (see FIG. 4) determines an Ultra High Reliability Basic Service Set Parameters Change Count (UHR BPCC) field. This field is configured for inclusion within both a multi-link element and a Reduced Neighbor Report (RNR) of a management frame. For instance, in a hospital wireless deployment, a medical device as described in FIG. 3 may use the UHR BPCC field to track changes in network reliability parameters, ensuring that life-critical data transmissions are prioritized and that all access points and devices are aware of recent modifications.

At block 204, the device increments the UHR BPCC field and a corresponding critical update generation field. This step can be performed independently by each access point within a multi-link device or collectively for the entire multi-link device, as outlined in the process and supported by the flexible architecture shown in FIG. 3. For example, in a large enterprise office, if a network administrator updates Wi-Fi security settings simultaneously across multiple access points, each access point increments its UHR BPCC, reflecting the synchronized change throughout the deployment.

At block 206, the device sets a critical update flag within a Beacon frame transmitted by an access point. This flag is maintained for a defined duration that spans at least one Delivery Traffic Indication Map (DTIM) interval. The purpose is to signal the occurrence of a parameter change. The underlying hardware and firmware mechanisms to support this signaling can be implemented using the communications circuitry and processing elements depicted in FIG. 3 and FIG. 4. For a real-world example, consider a university campus where a new channel allocation is deployed overnight. The access points set the critical update flag to alert all connected and nearby devices to prepare for the upcoming transition, thereby minimizing connectivity disruptions.

At block 208, the device includes updated elements in the Beacon frame for the defined duration. These elements specify the critical update generation, target link, target beacon transmission time (TBTT) countdown to the parameter change, updated feature, and whether all updates appear in the current or a subsequent frame. This mechanism, as described in the context and supported by the flexible, programmable architecture shown in FIG. 3 and FIG. 4, ensures that client devices receive detailed and actionable information regarding network changes. For example, in an industrial IoT setting, when a factory access point updates its Non Persistent Channel Assignment parameters to avoid interference, the updated Beacon frames provide connected sensors and controllers with a countdown and specifics of the change, enabling seamless adaptation.

The integration of process 200 with the system architectures of FIG. 3 and FIG. 4 demonstrates how both hardware and software components collaborate to deliver enhanced reliability and responsiveness in wireless networks. These mechanisms are especially valuable in complex multi-link deployments where coordinated updates across multiple access points and client stations are essential for optimal performance and user experience.

In one or more embodiments, a device or system may be configured so that an Ultra High Reliability Basic Service Set Parameters Change Count field is included within both a multi-link element and a Reduced Neighbor Report for access points affiliated with the same access point multi-link device as the transmitting access point. Additionally, the field may be present in the Reduced Neighbor Report for access points that correspond to a non-transmitting basic service set identifier within the same multiple basic service set identifier grouping as the access point sending the frame. This flexible inclusion allows for adaptive communication strategies in complex wireless environments.

A device may be arranged to increment the Ultra High Reliability Basic Service Set Parameters Change Count field only when there is an update to a basic service set parameter that is not typically present in beacon frames. Crucially, this incrementing process may occur independently of changes to dynamic elements, enabling the system to avoid unnecessary updates and maintain operational efficiency. For example, if a security parameter is altered but routine dynamic fields remain unchanged, the count field may still be incremented to reflect only the critical update. This logic addresses the problem of excessive signaling overhead in multi-link wireless networks.

In response to a parameter change, the device may set a critical update flag to one and maintain it for multiple delivery traffic indication map intervals. The duration for which this flag remains active could be configured by the device, providing adaptability based on network requirements. As an illustration, the device may maintain the flag for three consecutive intervals to ensure that all connected stations are notified of a significant configuration change. This mechanism solves the issue of reliable dissemination of critical updates in environments with variable traffic patterns.

The device may structure the updated elements included in the beacon frame as a Critical Update element, which comprises subfields for critical update generation, a target link identifier, a countdown to the target beacon transmission time, updated parameter identification, and an indicator of whether the update appears in the current or a subsequent beacon frame. For instance, the Critical Update element might specify that a channel switch will occur in two beacon intervals and identify which link is affected. This structured approach ensures clarity and precision in update notifications.

In certain embodiments, the Critical Update element may further include a Parameter Update Type field and a list of parameters corresponding to the updated feature. The updated elements might also contain a Beacon Countdown field, which indicates the number of beacon intervals remaining before the new parameters become effective. The device may apply the Ultra High Reliability Basic Service Set Parameters Change Count field and the critical update procedure either independently for each access point of a multi-link device or collectively for the entire multi-link device. As a further example, the device could manage updates separately for each access point, allowing for tailored notifications based on individual link requirements. This flexibility addresses the challenge of coordinating updates across diverse network architectures.

It is understood that the above descriptions are for the purposes of illustration and are not meant to be limiting.

FIG. 3 shows a functional diagram of an exemplary communication station 300, in accordance with one or more example embodiments of the present disclosure. In one embodiment, FIG. 3 illustrates a functional block diagram of a communication station that may be suitable for use as an AP 102 (FIG. 1) or a user device 120 (FIG. 1) in accordance with some embodiments. The communication station 300 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 300 may include communications circuitry 302 and a transceiver 310 for transmitting and receiving signals to and from other communication stations using one or more antennas 301. The communications circuitry 302 may include circuitry that can operate the physical layer (PHY) communications and/or medium access control (MAC) communications for controlling access to the wireless medium, and/or any other communications layers for transmitting and receiving signals. The communication station 300 may also include processing circuitry 306 and memory 308 arranged to perform the operations described herein. In some embodiments, the communications circuitry 302 and the processing circuitry 306 may be configured to perform operations detailed in the above figures, diagrams, and flows.

In accordance with some embodiments, the communications circuitry 302 may be arranged to contend for a wireless medium and configure frames or packets for communicating over the wireless medium. The communications circuitry 302 may be arranged to transmit and receive signals. The communications circuitry 302 may also include circuitry for modulation/demodulation, upconversion/downconversion, filtering, amplification, etc. In some embodiments, the processing circuitry 306 of the communication station 300 may include one or more processors. In other embodiments, two or more antennas 301 may be coupled to the communications circuitry 302 arranged for sending and receiving signals. The memory 308 may store information for configuring the processing circuitry 306 to perform operations for configuring and transmitting message frames and performing the various operations described herein. The memory 308 may include any type of memory, including non-transitory memory, for storing information in a form readable by a machine (e.g., a computer). For example, the memory 308 may include a computer-readable storage device, read-only memory (ROM), random-access memory (RAM), magnetic disk storage media, optical storage media, flash-memory devices and other storage devices and media.

In some embodiments, the communication station 300 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 300 may include one or more antennas 301. The antennas 301 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 300 may include one or more of a keyboard, a display, a non-volatile memory port, multiple antennas, a graphics processor, an application processor, speakers, and other mobile device elements. The display may be an LCD screen including a touch screen.

Although the communication station 300 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 300 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 300 may include one or more processors and may be configured with instructions stored on a computer-readable storage device.

FIG. 4 illustrates a block diagram of an example of a machine 400 or system upon which any one or more of the techniques (e.g., methodologies) discussed herein may be performed. In other embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environments. The machine 400 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a power management device 432, a graphics display device 410, an alphanumeric input device 412 (e.g., a keyboard), and a user interface (UI) navigation device 414 (e.g., a mouse). In an example, the graphics display device 410, alphanumeric input device 412, and UI navigation device 414 may be a touch screen display. The machine 400 may additionally include a storage device (i.e., drive unit) 416, a signal generation device 418 (e.g., a speaker), an enhanced generation indication device 419, a network interface device/transceiver 420 coupled to antenna(s) 430, and one or more sensors 428, such as a global positioning system (GPS) sensor, a compass, an accelerometer, or other sensor. The machine 400 may include an output controller 434, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 402 for generation and processing of the baseband signals and for controlling operations of the main memory 404, the storage device 416, and/or the enhanced generation indication device 419. The baseband processor may be provided on a single radio card, a single chip, or an integrated circuit (IC).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within the static memory 406, or within the hardware processor 402 during execution thereof by the machine 400. In an example, one or any combination of the hardware processor 402, the main memory 404, the static memory 406, or the storage device 416 may constitute machine-readable media.

The enhanced generation indication device 419 may carry out or perform any of the operations and processes (e.g., process 200) described and shown above.

It is understood that the above are only a subset of what the enhanced generation indication device 419 may be configured to perform and that other functions included throughout this disclosure may also be performed by the enhanced generation indication device 419.

While the machine-readable medium 422 is illustrated as a single medium, the term “machine-readable medium” may include a single medium or multiple media (e.g., a centralized or distributed database, and/or associated caches and servers) configured to store the one or more instructions 424.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 400 and that cause the machine 400 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device/transceiver 420 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 420 may include one or more physical jacks (e.g., Ethernet, coaxial, or phone jacks) or one or more antennas to connect to the communications network 426. In an example, the network interface device/transceiver 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 400 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

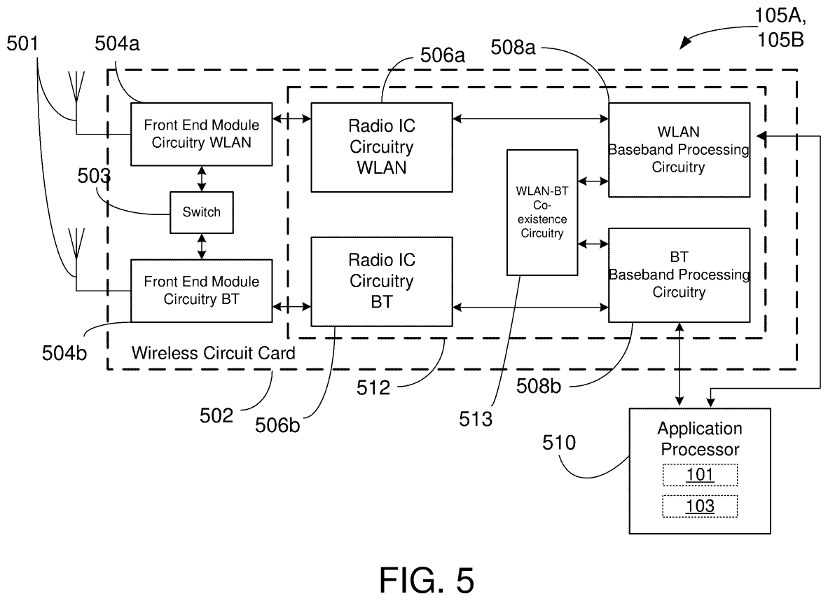

FIG. 5 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 504a-b, radio IC circuitry 506a-b and baseband processing circuitry 508a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 504a-b may include a WLAN or Wi-Fi FEM circuitry 504a and a Bluetooth (BT) FEM circuitry 504b. The WLAN FEM circuitry 504a may include a receive signal path comprising circuitry configured to operate on WLAN RF signals received from one or more antennas 501, to amplify the received signals and to provide the amplified versions of the received signals to the WLAN radio IC circuitry 506a for further processing. The BT FEM circuitry 504b may include a receive signal path which may include circuitry configured to operate on BT RF signals received from one or more antennas 501, to amplify the received signals and to provide the amplified versions of the received signals to the BT radio IC circuitry 506b for further processing. FEM circuitry 504a may also include a transmit signal path which may include circuitry configured to amplify WLAN signals provided by the radio IC circuitry 506a for wireless transmission by one or more of the antennas 501. In addition, FEM circuitry 504b may also include a transmit signal path which may include circuitry configured to amplify BT signals provided by the radio IC circuitry 506b for wireless transmission by the one or more antennas. In the embodiment of FIG. 5, although FEM 504a and FEM 504b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 506a-b as shown may include WLAN radio IC circuitry 506a and BT radio IC circuitry 506b. The WLAN radio IC circuitry 506a may include a receive signal path which may include circuitry to down-convert WLAN RF signals received from the FEM circuitry 504a and provide baseband signals to WLAN baseband processing circuitry 508a. BT radio IC circuitry 506b may in turn include a receive signal path which may include circuitry to down-convert BT RF signals received from the FEM circuitry 504b and provide baseband signals to BT baseband processing circuitry 508b. WLAN radio IC circuitry 506a may also include a transmit signal path which may include circuitry to up-convert WLAN baseband signals provided by the WLAN baseband processing circuitry 508a and provide WLAN RF output signals to the FEM circuitry 504a for subsequent wireless transmission by the one or more antennas 501. BT radio IC circuitry 506b may also include a transmit signal path which may include circuitry to up-convert BT baseband signals provided by the BT baseband processing circuitry 508b and provide BT RF output signals to the FEM circuitry 504b for subsequent wireless transmission by the one or more antennas 501. In the embodiment of FIG. 5, although radio IC circuitries 506a and 506b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 508a-b may include a WLAN baseband processing circuitry 508a and a BT baseband processing circuitry 508b. The WLAN baseband processing circuitry 508a may include a memory, such as, for example, a set of RAM arrays in a Fast Fourier Transform or Inverse Fast Fourier Transform block (not shown) of the WLAN baseband processing circuitry 508a. Each of the WLAN baseband circuitry 508a and the BT baseband circuitry 508b may further include one or more processors and control logic to process the signals received from the corresponding WLAN or BT receive signal path of the radio IC circuitry 506a-b, and to also generate corresponding WLAN or BT baseband signals for the transmit signal path of the radio IC circuitry 506a-b. Each of the baseband processing circuitries 508a and 508b may further include physical layer (PHY) and medium access control layer (MAC) circuitry, and may further interface with a device for generation and processing of the baseband signals and for controlling operations of the radio IC circuitry 506a-b.

Referring still to FIG. 5, according to the shown embodiment, WLAN-BT coexistence circuitry 513 may include logic providing an interface between the WLAN baseband circuitry 508a and the BT baseband circuitry 508b to enable use cases requiring WLAN and BT coexistence. In addition, a switch 503 may be provided between the WLAN FEM circuitry 504a and the BT FEM circuitry 504b to allow switching between the WLAN and BT radios according to application needs. In addition, although the antennas 501 are depicted as being respectively connected to the WLAN FEM circuitry 504a and the BT FEM circuitry 504b, embodiments include within their scope the sharing of one or more antennas as between the WLAN and BT FEMs, or the provision of more than one antenna connected to each of FEM 504a or 504b.

In some embodiments, the front-end module circuitry 504a-b, the radio IC circuitry 506a-b, and baseband processing circuitry 508a-b may be provided on a single radio card, such as wireless radio card 502. In some other embodiments, the one or more antennas 501, the FEM circuitry 504a-b and the radio IC circuitry 506a-b may be provided on a single radio card. In some other embodiments, the radio IC circuitry 506a-b and the baseband processing circuitry 508a-b may be provided on a single chip or integrated circuit (IC), such as IC 512.

In some embodiments, the wireless radio card 502 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

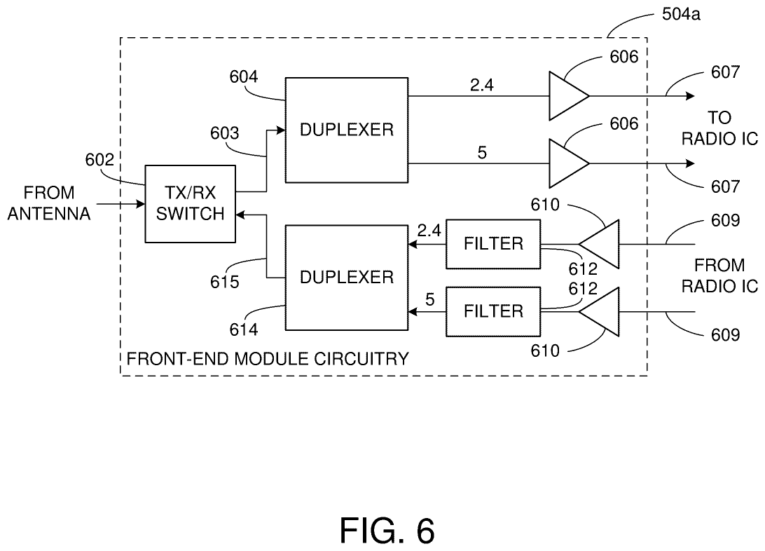

In some embodiments, as further shown in FIG. 6, the BT baseband circuitry 508b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

FIG. 6 illustrates WLAN FEM circuitry 504a in accordance with some embodiments. Although the example of FIG. 6 is described in conjunction with the WLAN FEM circuitry 504a, the example of FIG. 6 may be described in conjunction with the example BT FEM circuitry 504b (FIG. 5), although other circuitry configurations may also be suitable.

In some embodiments, the FEM circuitry 504a may include a TX/RX switch 602 to switch between transmit mode and receive mode operation. The FEM circuitry 504a may include a receive signal path and a transmit signal path. The receive signal path of the FEM circuitry 504a may include a low-noise amplifier (LNA) 606 to amplify received RF signals 603 and provide the amplified received RF signals 607 as an output (e.g., to the radio IC circuitry 506a-b (FIG. 5)). The transmit signal path of the circuitry 504a may include a power amplifier (PA) to amplify input RF signals 609 (e.g., provided by the radio IC circuitry 506a-b), and one or more filters 612, such as band-pass filters (BPFs), low-pass filters (LPFs) or other types of filters, to generate RF signals 615 for subsequent transmission (e.g., by one or more of the antennas 501 (FIG. 5)) via an example duplexer 614.

In some dual-mode embodiments for Wi-Fi communication, the FEM circuitry 504a may be configured to operate in either the 2.4 GHz frequency spectrum or the 5 GHz frequency spectrum. In these embodiments, the receive signal path of the FEM circuitry 504a may include a receive signal path duplexer 604 to separate the signals from each spectrum as well as provide a separate LNA 606 for each spectrum as shown. In these embodiments, the transmit signal path of the FEM circuitry 504a may also include a power amplifier 610 and a filter 612, such as a BPF, an LPF or another type of filter for each frequency spectrum and a transmit signal path duplexer 604 to provide the signals of one of the different spectrums onto a single transmit path for subsequent transmission by the one or more of the antennas 501 (FIG. 5). In some embodiments, BT communications may utilize the 2.4 GHz signal paths and may utilize the same FEM circuitry 504a as the one used for WLAN communications.

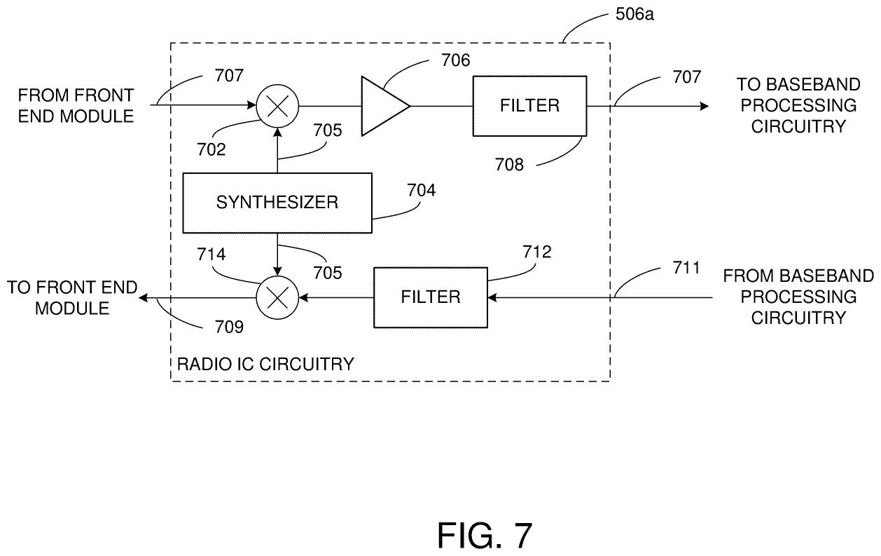

FIG. 7 illustrates radio IC circuitry 506a in accordance with some embodiments. The radio IC circuitry 506a is one example of circuitry that may be suitable for use as the WLAN or BT radio IC circuitry 506a/506b (FIG. 5), although other circuitry configurations may also be suitable. Alternatively, the example of FIG. 7 may be described in conjunction with the example BT radio IC circuitry 506b.

In some embodiments, the radio IC circuitry 506a may include a receive signal path and a transmit signal path. The receive signal path of the radio IC circuitry 506a may include at least mixer circuitry 702, such as, for example, down-conversion mixer circuitry, amplifier circuitry 706 and filter circuitry 708. The transmit signal path of the radio IC circuitry 506a may include at least filter circuitry 712 and mixer circuitry 714, such as, for example, up-conversion mixer circuitry. Radio IC circuitry 506a may also include synthesizer circuitry 704 for synthesizing a frequency 705 for use by the mixer circuitry 702 and the mixer circuitry 714. The mixer circuitry 702 and/or 714 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 7 illustrates only a simplified version of a radio IC circuitry, and may include, although not shown, embodiments where each of the depicted circuitries may include more than one component. For instance, mixer circuitry 714 may each include one or more mixers, and filter circuitries 708 and/or 712 may each include one or more filters, such as one or more BPFs and/or LPFs according to application needs. For example, when mixer circuitries are of the direct-conversion type, they may each include two or more mixers.

In some embodiments, mixer circuitry 702 may be configured to down-convert RF signals 607 received from the FEM circuitry 504a-b (FIG. 5) based on the synthesized frequency 705 provided by synthesizer circuitry 704. The amplifier circuitry 706 may be configured to amplify the down-converted signals and the filter circuitry 708 may include an LPF configured to remove unwanted signals from the down-converted signals to generate output baseband signals 707. Output baseband signals 707 may be provided to the baseband processing circuitry 508a-b (FIG. 5) for further processing. In some embodiments, the output baseband signals 707 may be zero-frequency baseband signals, although this is not a requirement. In some embodiments, mixer circuitry 702 may comprise passive mixers, although the scope of the embodiments is not limited in this respect.

In some embodiments, the mixer circuitry 714 may be configured to up-convert input baseband signals 711 based on the synthesized frequency 705 provided by the synthesizer circuitry 704 to generate RF output signals 609 for the FEM circuitry 504a-b. The baseband signals 711 may be provided by the baseband processing circuitry 508a-b and may be filtered by filter circuitry 712. The filter circuitry 712 may include an LPF or a BPF, although the scope of the embodiments is not limited in this respect.

In some embodiments, the mixer circuitry 702 and the mixer circuitry 714 may each include two or more mixers and may be arranged for quadrature down-conversion and/or up-conversion respectively with the help of synthesizer 704. In some embodiments, the mixer circuitry 702 and the mixer circuitry 714 may each include two or more mixers each configured for image rejection (e.g., Hartley image rejection). In some embodiments, the mixer circuitry 702 and the mixer circuitry 714 may be arranged for direct down-conversion and/or direct up-conversion, respectively. In some embodiments, the mixer circuitry 702 and the mixer circuitry 714 may be configured for super-heterodyne operation, although this is not a requirement.

Mixer circuitry 702 may comprise, according to one embodiment: quadrature passive mixers (e.g., for the in-phase (I) and quadrature phase (Q) paths). In such an embodiment, RF input signal 607 from FIG. 7 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 705 of synthesizer 704 (FIG. 7). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 607 (FIG. 6) may comprise a balanced signal, although the scope of the embodiments is not limited in this respect. The I and Q baseband output signals may be provided to low-noise amplifier, such as amplifier circuitry 706 (FIG. 7) or to filter circuitry 708 (FIG. 7).

In some embodiments, the output baseband signals 707 and the input baseband signals 711 may be analog baseband signals, although the scope of the embodiments is not limited in this respect. In some alternate embodiments, the output baseband signals 707 and the input baseband signals 711 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 704 may be a fractional-N synthesizer or a fractional N/N+1 synthesizer, although the scope of the embodiments is not limited in this respect as other types of frequency synthesizers may be suitable. For example, synthesizer circuitry 704 may be a delta-sigma synthesizer, a frequency multiplier, or a synthesizer comprising a phase-locked loop with a frequency divider. According to some embodiments, the synthesizer circuitry 704 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 704 may be provided by a voltage controlled oscillator (VCO), although that is not a requirement. A divider control input may further be provided by either the baseband processing circuitry 508a-b (FIG. 5) depending on the desired output frequency 705. In some embodiments, a divider control input (e.g., N) may be determined from a look-up table (e.g., within a Wi-Fi card) based on a channel number and a channel center frequency as determined or indicated by the example application processor 510. The application processor 510 may include, or otherwise be connected to, one of the example secure signal converter 101 or the example received signal converter 103 (e.g., depending on which device the example radio architecture is implemented in).

In some embodiments, synthesizer circuitry 704 may be configured to generate a carrier frequency as the output frequency 705, while in other embodiments, the output frequency 705 may be a fraction of the carrier frequency (e.g., one-half the carrier frequency, one-third the carrier frequency). In some embodiments, the output frequency 705 may be a LO frequency (fLO).

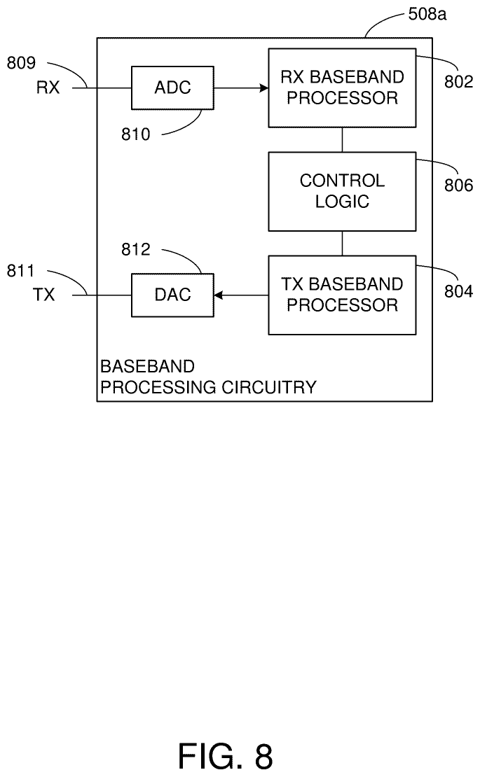

FIG. 8 illustrates a functional block diagram of baseband processing circuitry 508a in accordance with some embodiments. The baseband processing circuitry 508a is one example of circuitry that may be suitable for use as the baseband processing circuitry 508a (FIG. 5), although other circuitry configurations may also be suitable. Alternatively, the example of FIG. 7 may be used to implement the example BT baseband processing circuitry 508b of FIG. 5.

The baseband processing circuitry 508a may include a receive baseband processor (RX BBP) 802 for processing receive baseband signals 709 provided by the radio IC circuitry 506a-b (FIG. 5) and a transmit baseband processor (TX BBP) 804 for generating transmit baseband signals 711 for the radio IC circuitry 506a-b. The baseband processing circuitry 508a may also include control logic 806 for coordinating the operations of the baseband processing circuitry 508a.

In some embodiments (e.g., when analog baseband signals are exchanged between the baseband processing circuitry 508a-b and the radio IC circuitry 506a-b), the baseband processing circuitry 508a may include ADC 810 to convert analog baseband signals 809 received from the radio IC circuitry 506a-b to digital baseband signals for processing by the RX BBP 802. In these embodiments, the baseband processing circuitry 508a may also include DAC 812 to convert digital baseband signals from the TX BBP 804 to analog baseband signals 811.

In some embodiments that communicate OFDM signals or OFDMA signals, such as through baseband processor 508a, the transmit baseband processor 804 may be configured to generate OFDM or OFDMA signals as appropriate for transmission by performing an inverse fast Fourier transform (IFFT). The receive baseband processor 802 may be configured to process received OFDM signals or OFDMA signals by performing an FFT. In some embodiments, the receive baseband processor 802 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 5, in some embodiments, the antennas 501 (FIG. 5) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 501 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: determine an Ultra High Reliability Basic Service Set Parameters Change Count (UHR BPCC) field, wherein the UHR BPCC field may be configured for inclusion within a multi-link element and a Reduced Neighbor Report (RNR) of a management frame; increment the UHR BPCC field and a corresponding critical update generation field; set a critical update flag within a Beacon frame transmitted by an access point (AP), the critical update flag maintained for a defined duration spanning at least one Delivery Traffic Indication Map (DTIM) interval to signal an occurrence of a parameter change; and include updated elements in the Beacon frame for the defined duration, specifying the critical update generation, target link, target beacon transmission time (TBTT) countdown to the parameter change, updated feature, and whether all updates appear in a current or a later frame.

Example 2 may include the device of example 1 and/or some other example(s) herein, wherein the UHR BPCC field may be included within the multi-link element and the RNR for APs affiliated with the same AP Multi-link Device (AP MLD) as the AP sending the frame.

Example 3 may include the device of example 1 and/or some other example(s) herein, wherein the UHR BPCC field may be included within the RNR for APs corresponding to a non-transmitting Basic Service Set Identifier (nonTx BSSID) in the same Multiple BSSID set as the AP sending the frame.

Example 4 may include the device of example 1 and/or some other example(s) herein, wherein the UHR BPCC field may be incremented solely upon an update to a BSS parameter not typically included in Beacon frames, wherein the incrementing of the UHR BPCC field may be independent of dynamic element changes.

Example 5 may include the device of example 1 and/or some other example(s) herein, wherein the critical update flag may be set to one and maintained for multiple DTIM intervals following a parameter change, wherein the duration may be configurable by the processing circuitry.

Example 6 may include the device of example 1 and/or some other example(s) herein, wherein the updated elements included in the Beacon frame are structured as a Critical Update element comprising subfields for critical update generation, target link identifier, TBTT countdown, updated parameter identification, and a field indicating inclusion status within the Beacon frame or a subsequent frame.

Example 7 may include the device of example 6 and/or some other example(s) herein, wherein the Critical Update element further may include a Parameter Update Type field and a list of parameters corresponding to the updated feature.

Example 8 may include the device of example 1 and/or some other example(s) herein, wherein the updated elements include a Beacon Countdown field indicating a number of Beacon intervals before an updated parameters become effective.

Example 9 may include the device of example 1 and/or some other example(s) herein, wherein the processing circuitry may be further configured to apply the UHR BPCC field and critical update procedure independently for each AP of an AP MLD or collectively for the AP MLD.

Example 10 may include a non-transitory computer-readable medium storing computer-executable instructions which when executed by one or more processors result in performing operations comprising: determining an Ultra High Reliability Basic Service Set Parameters Change Count (UHR BPCC) field, wherein the UHR BPCC field may be configured for inclusion within a multi-link element and a Reduced Neighbor Report (RNR) of a management frame; increment the UHR BPCC field and a corresponding critical update generation field; setting a critical update flag within a Beacon frame transmitted by an access point (AP), the critical update flag maintained for a defined duration spanning at least one Delivery Traffic Indication Map (DTIM) interval to signal an occurrence of a parameter change; and including updated elements in the Beacon frame for the defined duration, specifying the critical update generation, target link, target beacon transmission time (TBTT) countdown to the parameter change, updated feature, and whether all updates appear in a current or a later frame.

Example 11 may include the non-transitory computer-readable medium of example 10 and/or some other example(s) herein, wherein the UHR BPCC field may be included within the multi-link element and the RNR for APs affiliated with the same AP Multi-link Device (AP MLD) as the AP sending the frame.

Example 12 may include the non-transitory computer-readable medium of example 10 and/or some other example(s) herein, wherein the UHR BPCC field may be included within the RNR for APs corresponding to a non-transmitting Basic Service Set Identifier (nonTx BSSID) in the same Multiple BSSID set as the AP sending the frame.

Example 13 may include the non-transitory computer-readable medium of example 10 and/or some other example(s) herein, wherein the UHR BPCC field may be incremented solely upon an update to a BSS parameter not typically included in Beacon frames, wherein the incrementing of the UHR BPCC field may be independent of dynamic element changes.

Example 14 may include the non-transitory computer-readable medium of example 10 and/or some other example(s) herein, wherein the critical update flag may be set to one and maintained for multiple DTIM intervals following a parameter change, wherein the duration may be configurable by the processing circuitry.

Example 15 may include the non-transitory computer-readable medium of example 10 and/or some other example(s) herein, wherein the updated elements included in the Beacon frame are structured as a Critical Update element comprising subfields for critical update generation, target link identifier, TBTT countdown, updated parameter identification, and a field indicating inclusion status within the Beacon frame or a subsequent frame.

Example 16 may include the non-transitory computer-readable medium of example 15 and/or some other example(s) herein, wherein the Critical Update element further may include a Parameter Update Type field and a list of parameters corresponding to the updated feature.

Example 17 may include the non-transitory computer-readable medium of example 10 and/or some other example(s) herein, wherein the updated elements include a Beacon Countdown field indicating a number of Beacon intervals before an updated parameters become effective.

Example 18 may include the non-transitory computer-readable medium of example 10 and/or some other example(s) herein, wherein the operations further comprise applying the UHR BPCC field and critical update procedure independently for each AP of an AP MLD or collectively for the AP MLD.

Example 19 may include a method comprising: determining an Ultra High Reliability Basic Service Set Parameters Change Count (UHR BPCC) field, wherein the UHR BPCC field may be configured for inclusion within a multi-link element and a Reduced Neighbor Report (RNR) of a management frame; increment the UHR BPCC field and a corresponding critical update generation field; setting a critical update flag within a Beacon frame transmitted by an access point (AP), the critical update flag maintained for a defined duration spanning at least one Delivery Traffic Indication Map (DTIM) interval to signal an occurrence of a parameter change; and including updated elements in the Beacon frame for the defined duration, specifying the critical update generation, target link, target beacon transmission time (TBTT) countdown to the parameter change, updated feature, and whether all updates appear in a current or a later frame.

Example 20 may include the method of example 19 and/or some other example(s) herein, wherein the UHR BPCC field may be included within the multi-link element and the RNR for APs affiliated with the same AP Multi-link Device (AP MLD) as the AP sending the frame.

Example 21 may include the method of example 19 and/or some other example(s) herein, wherein the UHR BPCC field may be included within the RNR for APs corresponding to a non-transmitting Basic Service Set Identifier (nonTx BSSID) in the same Multiple BSSID set as the AP sending the frame.

Example 22 may include the method of example 19 and/or some other example(s) herein, wherein the UHR BPCC field may be incremented solely upon an update to a BSS parameter not typically included in Beacon frames, wherein the incrementing of the UHR BPCC field may be independent of dynamic element changes.

Example 23 may include the method of example 19 and/or some other example(s) herein, wherein the critical update flag may be set to one and maintained for multiple DTIM intervals following a parameter change, wherein the duration may be configurable by the processing circuitry.

Example 24 may include the method of example 19 and/or some other example(s) herein, wherein the updated elements included in the Beacon frame are structured as a Critical Update element comprising subfields for critical update generation, target link identifier, TBTT countdown, updated parameter identification, and a field indicating inclusion status within the Beacon frame or a subsequent frame.

Example 25 may include the method of example 24 and/or some other example(s) herein, wherein the Critical Update element further may include a Parameter Update Type field and a list of parameters corresponding to the updated feature.

Example 26 may include the method of example 19 and/or some other example(s)herein, wherein the updated elements include a Beacon Countdown field indicating a number of Beacon intervals before an updated parameters become effective.

Example 27 may include the method of example 19 and/or some other example(s)herein, further comprising applying the UHR BPCC field and critical update procedure independently for each AP of an AP MLD or collectively for the AP MLD.

Example 28 may include an apparatus comprising means for: determining an Ultra High Reliability Basic Service Set Parameters Change Count (UHR BPCC) field, wherein the UHR BPCC field may be configured for inclusion within a multi-link element and a Reduced Neighbor Report (RNR) of a management frame; increment the UHR BPCC field and a corresponding critical update generation field; setting a critical update flag within a Beacon frame transmitted by an access point (AP), the critical update flag maintained for a defined duration spanning at least one Delivery Traffic Indication Map (DTIM) interval to signal an occurrence of a parameter change; and including updated elements in the Beacon frame for the defined duration, specifying the critical update generation, target link, target beacon transmission time (TBTT) countdown to the parameter change, updated feature, and whether all updates appear in a current or a later frame.

Example 29 may include the apparatus of example 28 and/or some other example(s) herein, wherein the UHR BPCC field may be included within the multi-link element and the RNR for APs affiliated with the same AP Multi-link Device (AP MLD) as the AP sending the frame.

Example 30 may include the apparatus of example 28 and/or some other example(s) herein, wherein the UHR BPCC field may be included within the RNR for APs corresponding to a non-transmitting Basic Service Set Identifier (nonTx BSSID) in the same Multiple BSSID set as the AP sending the frame.

Example 31 may include the apparatus of example 28 and/or some other example(s) herein, wherein the UHR BPCC field may be incremented solely upon an update to a BSS parameter not typically included in Beacon frames, wherein the incrementing of the UHR BPCC field may be independent of dynamic element changes.

Example 32 may include the apparatus of example 28 and/or some other example(s) herein, wherein the critical update flag may be set to one and maintained for multiple DTIM intervals following a parameter change, wherein the duration may be configurable by the processing circuitry.

Example 33 may include the apparatus of example 28 and/or some other example(s) herein, wherein the updated elements included in the Beacon frame are structured as a Critical Update element comprising subfields for critical update generation, target link identifier, TBTT countdown, updated parameter identification, and a field indicating inclusion status within the Beacon frame or a subsequent frame.

Example 34 may include the apparatus of example 33 and/or some other example(s) herein, wherein the Critical Update element further may include a Parameter Update Type field and a list of parameters corresponding to the updated feature.

Example 35 may include the apparatus of example 28 and/or some other example(s) herein, wherein the updated elements include a Beacon Countdown field indicating a number of Beacon intervals before an updated parameters become effective.

Example 36 may include the apparatus of example 28 and/or some other example(s) herein, further comprising applying the UHR BPCC field and critical update procedure independently for each AP of an AP MLD or collectively for the AP MLD.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
determine an Ultra High Reliability Basic Service Set Parameters Change Count (UHR BPCC) field, wherein the UHR BPCC field is configured for inclusion within a multi-link element and a Reduced Neighbor Report (RNR) of a management frame;
increment the UHR BPCC field and a corresponding critical update generation field;
set a critical update flag within a Beacon frame transmitted by an access point (AP), the critical update flag maintained for a defined duration spanning at least one Delivery Traffic Indication Map (DTIM) interval to signal an occurrence of a parameter change; and
include updated elements in the Beacon frame for the defined duration, specifying the critical update generation, target link, target beacon transmission time (TBTT) countdown to the parameter change, updated feature, and whether all updates appear in a current or a later frame.

2. The device of claim 1, wherein the UHR BPCC field is included within the multi-link element and the RNR for APs affiliated with the same AP Multi-link Device (AP MLD) as the AP sending the frame.

3. The device of claim 1, wherein the UHR BPCC field is included within the RNR for APs corresponding to a non-transmitting Basic Service Set Identifier (nonTx BSSID) in the same Multiple BSSID set as the AP sending the frame.

4. The device of claim 1, wherein the UHR BPCC field is incremented solely upon an update to a BSS parameter not typically included in Beacon frames, wherein the incrementing of the UHR BPCC field is independent of dynamic element changes.

5. The device of claim 1, wherein the critical update flag is set to one and maintained for multiple DTIM intervals following a parameter change, wherein the duration is configurable by the processing circuitry.

6. The device of claim 1, wherein the updated elements included in the Beacon frame are structured as a Critical Update element comprising subfields for critical update generation, target link identifier, TBTT countdown, updated parameter identification, and a field indicating inclusion status within the Beacon frame or a subsequent frame.

7. The device of claim 6, wherein the Critical Update element further includes a Parameter Update Type field and a list of parameters corresponding to the updated feature.

8. The device of claim 1, wherein the updated elements include a Beacon Countdown field indicating a number of Beacon intervals before an updated parameters become effective.

9. The device of claim 1, wherein the processing circuitry is further configured to apply the UHR BPCC field and critical update procedure independently for each AP of an AP MLD or collectively for the AP MLD.

10. A non-transitory computer-readable medium storing computer-executable instructions which when executed by one or more processors result in performing operations comprising:
determining an Ultra High Reliability Basic Service Set Parameters Change Count (UHR BPCC) field, wherein the UHR BPCC field is configured for inclusion within a multi-link element and a Reduced Neighbor Report (RNR) of a management frame;
increment the UHR BPCC field and a corresponding critical update generation field;
setting a critical update flag within a Beacon frame transmitted by an access point (AP), the critical update flag maintained for a defined duration spanning at least one Delivery Traffic Indication Map (DTIM) interval to signal an occurrence of a parameter change; and
including updated elements in the Beacon frame for the defined duration, specifying the critical update generation, target link, target beacon transmission time (TBTT) countdown to the parameter change, updated feature, and whether all updates appear in a current or a later frame.

11. The non-transitory computer-readable medium of claim 10, wherein the UHR BPCC field is included within the multi-link element and the RNR for APs affiliated with the same AP Multi-link Device (AP MLD) as the AP sending the frame.

12. The non-transitory computer-readable medium of claim 10, wherein the UHR BPCC field is included within the RNR for APs corresponding to a non-transmitting Basic Service Set Identifier (nonTx BSSID) in the same Multiple BSSID set as the AP sending the frame.

13. The non-transitory computer-readable medium of claim 10, wherein the UHR BPCC field is incremented solely upon an update to a BSS parameter not typically included in Beacon frames, wherein the incrementing of the UHR BPCC field is independent of dynamic element changes.

14. The non-transitory computer-readable medium of claim 10, wherein the critical update flag is set to one and maintained for multiple DTIM intervals following a parameter change, wherein the duration is configurable by the processing circuitry.

15. The non-transitory computer-readable medium of claim 10, wherein the updated elements included in the Beacon frame are structured as a Critical Update element comprising subfields for critical update generation, target link identifier, TBTT countdown, updated parameter identification, and a field indicating inclusion status within the Beacon frame or a subsequent frame.

16. The non-transitory computer-readable medium of claim 15, wherein the Critical Update element further includes a Parameter Update Type field and a list of parameters corresponding to the updated feature.

17. The non-transitory computer-readable medium of claim 10, wherein the updated elements include a Beacon Countdown field indicating a number of Beacon intervals before an updated parameters become effective.

18. The non-transitory computer-readable medium of claim 10, wherein the operations further comprise applying the UHR BPCC field and critical update procedure independently for each AP of an AP MLD or collectively for the AP MLD.

19. A method comprising:
determining an Ultra High Reliability Basic Service Set Parameters Change Count (UHR BPCC) field, wherein the UHR BPCC field is configured for inclusion within a multi-link element and a Reduced Neighbor Report (RNR) of a management frame;
increment the UHR BPCC field and a corresponding critical update generation field;
setting a critical update flag within a Beacon frame transmitted by an access point (AP), the critical update flag maintained for a defined duration spanning at least one Delivery Traffic Indication Map (DTIM) interval to signal an occurrence of a parameter change; and
including updated elements in the Beacon frame for the defined duration, specifying the critical update generation, target link, target beacon transmission time (TBTT) countdown to the parameter change, updated feature, and whether all updates appear in a current or a later frame.

20. The method of claim 19, wherein the UHR BPCC field is included within the multi-link element and the RNR for APs affiliated with the same AP Multi-link Device (AP MLD) as the AP sending the frame.
